(19) United States
(12) Patent Application Publication
(10) Pub. No.: US 2012/0116006 A1
(43) Pub. Date: May 10, 2012

(54) Polymer Encapsulation Of Particles

(76) Inventors: Doris Pik-Yiu Chun, Sunnyvale, CA (US); Hou T. Ng, Palo Alto, CA (US)

(21) Appl. No.: 13/384,235

(22) PCT Filed: Jul. 31, 2009
(86) PCT No.: PCT/US09/52484

§ 371 Date: Jan. 15, 2012

(51) Int. Cl. C08L 33/12

(52) U.S. Cl. 524/522; 524/558

(57) ABSTRACT

Methods of encapsulating particles (260) in polymer (275, 380, 385) and compositions of matter using such encapsulated particles (260). Methods include mixing particles (260) of one or more materials with one or more initial polymerizable monomers (265) to form a first suspension of monomer-wetted particles (260/265), mixing the first suspension with an aqueous dispersant medium (270) to form a second suspension, adding one or more initial reaction initiators to at least one of the first suspension and the second suspension, subjecting the second suspension to homogenization to form a stable submicron emulsion having an aqueous continuous phase, and reacting available polymerizable monomers (265) of the emulsion to encapsulate the particles (260) in one or more layers of polymer (275, 380, 385).

### BACKGROUND

In a typical inkjet recording or printing system, droplets of marking fluid, sometimes referred to as ink, are ejected from a nozzle, i.e., jetted, towards a recording medium to produce an image on the medium. The droplets generally include a colorant, such as one or more dyes or pigments, for marking the medium, and some aqueous or solvent-based carrier vehicle to facilitate controlled ejection of the marking fluid. While aqueous carrier vehicles are more environmentally friendly than solvent-based carrier vehicles, their colorants are usually more prone to smearing or durability concerns.

For the reasons stated above, and for other reasons that will become apparent to those skilled in the art upon reading and understanding the present specification, alternative methods of encapsulating particles for use in marking fluids and other applications are desirable.

### BRIEF DESCRIPTION OF THE DRAWINGS

FIG. 1 is a flowchart of a method of forming encapsulated particles in accordance with an embodiment of the disclosure.

FIGS. 2A-2C are representations of process mixtures at various stages of the method of FIG. 2.

FIGS. 3A-3C are representations of an encapsulated particle having one or more layers of encapsulant material in accordance with embodiments of the disclosure.

FIGS. 4A-4D are transmission electron micrograph (TEM) images of encapsulated particles produced in accordance with embodiments of the disclosure.

### DETAILED DESCRIPTION

In the following detailed description of the present embodiments, reference is made to the accompanying drawings that form a part hereof, and in which is shown by way of illustration specific embodiments of the disclosure which may be practiced. These embodiments are described in sufficient detail to enable those skilled in the art to practice the subject matter of the disclosure, and it is to be understood that other embodiments may be utilized and that process, chemical or mechanical changes may be made without departing from the scope of the present disclosure. The following detailed description is, therefore, not to be taken in a limiting sense, and the scope of the present disclosure is defined by the appended claims and equivalents thereof.

Colorant in a marking fluid may be covered by a polymeric coating to alter its performance characteristics, such as waterfastness, lightfastness, durability, substrate adhesion, optical qualities, print qualities and deinkability. Oftentimes, however, there is little to no control over the absolute thickness of the polymeric coating, which can lead to undesirable variations in print quality as well as difficulties in jetting the marking fluid if the particle size falls outside of the desired range. Furthermore, insufficient thickness can reduce durability and rub resistance of the applied marking fluid.

The various embodiments employ high-pressure high-shear homogenization techniques, such as microfluidization, in a sequential process to form homogenously stabilized emulsions. The emulsions include a continuous phase containing water and a discontinuous phase including particles encapsulated in one or more polymerizable monomers. The emulsions may further include surfactant(s), co-surfactant(s), reaction initiator(s), polymer(s), thickener(s), cross-linker(s) and the like to aid in formation and polymerization of the emulsion. The polymeric encapsulant is formed through reaction of the polymerizable monomers. For some embodiments, the particles have dimensions of less than one micron, which are sometimes referred to as nanoparticles.

Embodiments described herein provide a direct yet scalable approach to control encapsulant thickness. Particle size is a critical parameter for optimal performance in many applications, but is often difficult to achieve. In inkjet printing, a particle size affects jetting. And while the example embodiments are directed to encapsulated colorants, such as pigments for inkjet ink, the methods described herein are suitable for use in a variety of applications, e.g., encapsulation of biological or pharmaceutical solids. For example, in biological systems, larger particles can be retained in tissues and organs as a way of localizing drug dosage for therapy, e.g., boron neutron capture therapy. Thus, the ability to control particle size is a powerful tool which can dramatically expand the possible applications of the resulting encapsulated product. An additional advantage of methods of various embodiments is that they allow encapsulant with varying material compositions to be incorporated, providing controlled physicochemical properties of the encapsulated particles. For example, a particle may be encapsulated by a layer of a first polymeric material having a first particular thickness, followed by a layer of a second polymeric material having a second particular thickness.

Various embodiments include methods of encapsulating particles, e.g., nanoparticles, in a polymer encapsulant. The methods include mixing the particles in the presence of one or more polymerizable monomers to wet the surfaces of the particles with the monomers. The particles can include one or more colorants, such as organic pigments, e.g., CuPc-based (copper phthalocyanine-based) pigments, and inorganic pigments, e.g., titania- or silica-based pigments. Such embodiments containing colorants can be used in the formulation of marking fluids. The particles may further include other solids, such as quantum dots, metal oxides, colloids, pharmaceuticals, etc. for a variety of other applications. For various embodiments, the particles may be mixed in the presence of the polymerizable monomer mixture along with one or more additional reagents, such as reaction initiator(s), polymer(s), thickener(s), cross-linker(s) and the like to aid in formation and polymerization of the subsequent emulsion, or to modify the properties of the end product.

The methods further include adding an aqueous dispersant medium, such as water and surfactant(s), to the solids/monomer mix and subjecting the resultant heterogeneous mixture to microfluidization or other such homogenization until a stable submicron emulsion is obtained. The process conditions of the microfluidization and materials loading can be adjusted to obtain a particular particle size having a specific colorant-to-monomer ratio in the solids/monomer mix within the aqueous continuous phase. The emulsion is then subjected to reaction initiation. For some embodiments, this reaction is initiated with insufficient reaction initiator in the initial emulsion to complete polymerization of the available monomer to produce polymer “seed” particles and to provide control of the polymerization reaction. Additional reaction initiator is then added to complete the polymerization. Such further addition of initiator can be performed over a period of time with or without the addition of further monomer mix. Using monomer-starved conditions, the thickness of the polymer encapsulant can be built up in a controlled manner. That is, the reaction can begin to encapsulate the particles in polymer, and then additional monomer can be added to continue to feed the reaction, resulting in further growth of the polymer encapsulant. In addition, by altering the monomer composition over time, the composition of the resulting polymer encapsulant can be altered in response to the monomer composition at the time of reaction.

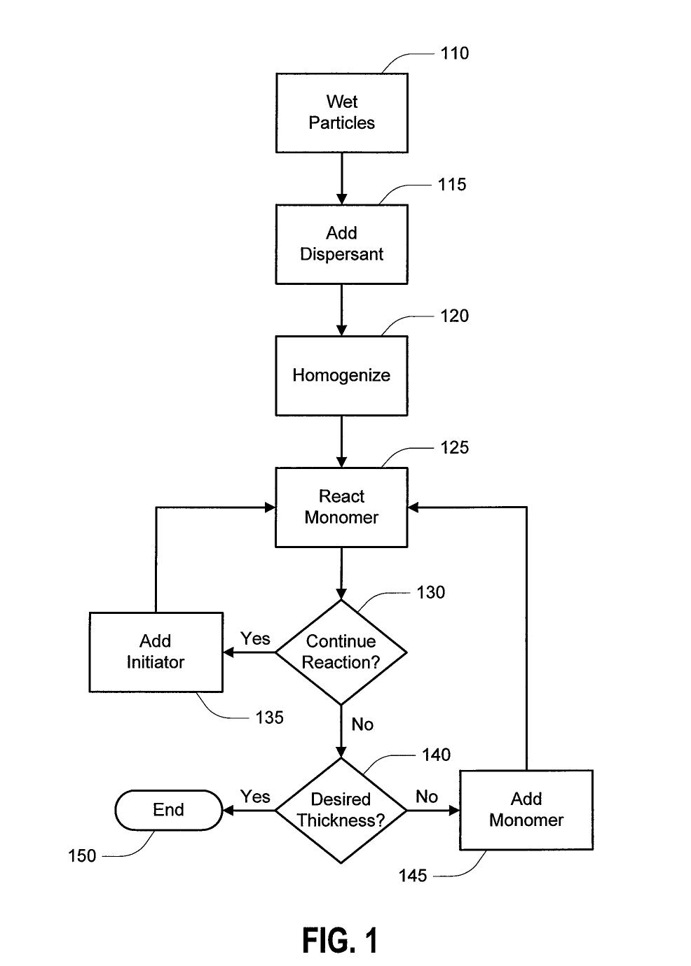

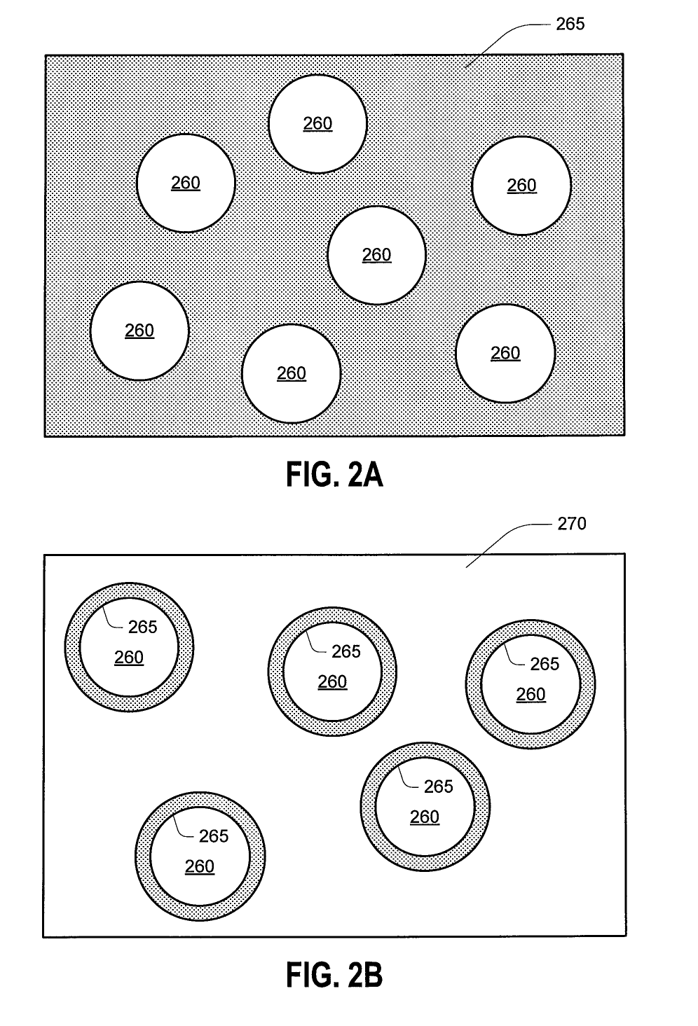

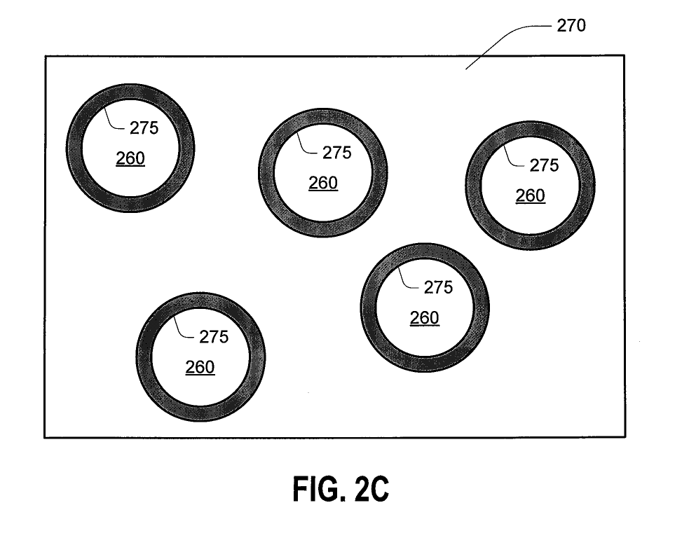

FIG. 1 is a flowchart of a method of forming encapsulated particles in accordance with an embodiment of the disclosure. Mechanical mixing of at least the particles and one or more polymerizable monomers is performed at 110 to wet the particles with the monomers, forming a suspension. Such mixing may further be performed in combination with shearing, such as through grinding, milling or otherwise inducing shear, to cause a reduction in the average particle size of the particles and to aid in surface wetting of the particle surfaces. FIG. 2A is a representation of particles 260 wetted in a monomer 265.

The particles may include one or more materials. For example, the particles may represent a single material or a mixture of two or more different materials. The particle materials include, for example, organic or inorganic pigments or other colorants, quantum dots, metal oxides, colloids, etc. The particles are generally in dried form. Binders may be added to aid in wetting the surfaces of the particles. For example, a halogenated aromatic solvent may be added if the particles are incompatible with the monomers to improve the wettability of their surfaces.

The one or more polymerizable monomers can include any polymerizable monomer, and the choice will depend upon the desired characteristics of the resulting polymer encapsulant. Some examples include any acrylic and methacrylic monomers such as linear, branched or cyclic aliphatic acrylates including but not limited to ethyl, propyl, isobutyl, butyl, tertarylbutyl, pentyl, hexyl, heptyl, octyl, nonyl, decyl, dodecyl, octadecyl, 2-ethylhexyl, lauryl, cyclohexyl acrylates, t-butylcyclohexyl, and functional monomers such as 2-hydroxylethyl, 2-hydroxylpropyl, 2-hydroxylbutyl, dimethylaminoethyl, glycidyl, butanediol, 2-carboxylethyl, 2-ethoxyethyl, di(ethylene glycol methyl ether, ethylene glycol methyl ether, ethylene glycol phenyl ether, 2-(4-benzoyl-3-hydroxyphenoxy)ethyl, 2-(dialkylamino)ethyl, 2-(dialkylamino)propyl, 2-[[(butylamino)carbonyl]-oxy]ethyl, 2-hydroxyl-3-phenoxypropyl, 3,5,5-trimethylhexyl, 3-(trimethyloxysilyl)propyl, 3-sulfopropyl, di(ethylene glycol)-2-ethylhexyl ether, dipentaerythritol penta-/hexa, ethyl 2-(trimethylsilylmethyl), ethyl-2-(trimethylsilylmethyl), alkylcyano, and ethylene glycol dicyclopentenyl ether acrylates.

In marking fluid formulations, unencapsulated pigments and pigment-free polymer formations can detrimentally occur from some prior encapsulation methods. For example, the homogenization of stabilized pigment dispersions with monomer dispersions can result in a significant amount of pigment-free colorless polymer due to the uneven distribution of pigment particles and monomer droplets during mixing. This gives rise to non-encapsulated pigment particles and polymer containing no pigment particles, which give undesirable print quality and consistency. Marking fluid containing pigment particles not coated with polymer will have undesirable performance such as poor smear-fastness, while pigment-free polymer can affect the optical density and hence the print quality of an image due to the uneven distribution of colorants. Various embodiments described herein address both of these known problems.

By grinding or otherwise shearing pigment (which may be surface treated, chemically treated, or raw) with the monomer blend, each discrete pigment particle can be brought into physical contact with the monomers. Due to the association of similar surface energies among the pigment particle surfaces and monomers arising from non-covalent interactions including but not limited to Van der Waals, hydrogen-bonding, acid-base, Zwitterionic, and static interactions, the monomers coat the pigment particle surfaces. There are two advantages associated with this method of monomer coating. First, it mediates the assembly of the pigment with the surfactant(s) of choice to form the final stable emulsion. Second, it facilitates the complete coverage of the individual pigment particles which will polymerize upon chemical, redox (reduction/oxidation) or thermal initiation to form a surrounding polymer encapsulant.

Reaction initiators and other reagents may also be added at 110 and thus to this first suspension, which may form a paste upon mixing. Example reaction initiators include water miscible or immiscible radical generators, including diazocompounds, peroxides, and redox initiators. Other reagents may include crosslinkers, co-surfactants (hydrophobic), rheology-control agents, chain transfer agents, RAFT (Reversible Addition-Fragmentation chain Transfer) agents (e.g. dithioesters), and non-aqueous solvents (e.g., halogenated/aromatic solvents) to affect the efficiency and quality of the reaction.

An aqueous dispersant medium is added to the first suspension at 115. The dispersant medium may include water and one or more surfactants or co-surfactants. As one example, the dispersant medium may contain 0.01 to 40 wt % of surfactant in water. Suitable surfactants and co-surfactants will depend upon the choice of monomers. Any desired reaction initiators and/or other reagents not added at 110 may be added at this time. The resulting mixture may further be mixed at this time. For example, the mixture may be subjected to high speed mixing, e.g., >500 rpm, for 0.01-10 hours to form a second suspension. For some embodiments, initiator(s) added at 110 and/or 115 are added at a quantity that is insufficient to completely react the initial available monomers.

The resulting second suspension is then subjected to homogenization, such as microfluidization, at 120. Microfluidization, as used herein, is the formation of submicron emulsions, i.e., emulsions having discontinuous phase droplets having dimensions of less than one micron. Example lab-scale dispersion apparatus for developing submicron emulsions include the VIBRACELL SONIC VCX-750 ultrasonifier and the MICROFLUIDICS Model 110-Y microfluidizer. Example industrial-scale dispersion apparatus for developing submicron emulsions include the HIELSCHER UIP4000 ultrasonicator or the MICROFLUIDICS Model M-710 series microfluidizers. Other homogenizers capable of forming submicron emulsions of the monomer-coated particles in an aqueous continuous phase may also be used. Adjusting the process conditions of homogenization, including operating conditions and equipment setup, can be used to further break down particles into a desired average size of the monomer-wetted particles in the aqueous continuous phase and/or control the degree of deagglomeration of monomer-wetted particles in the aqueous continuous phase. For example, control can be affected through variation of the amount of surfactant, the pressure for a homogenizer or amplitude of a sonifier probe, cycles of fluidization, microfluidizer chamber types and diameters, arrangements of microfluidizer interaction chamber versus auxiliary process module, etc. Particle composition within the agglomerates would be statistically based on the size of the particles and the weight ratios of component particles. FIG. 2B is a representation of an emulsion having an aqueous continuous phase 270, i.e., the aqueous dispersant medium, and a discontinuous phase having particles 260 encapsulated in monomer 265. Particles 260 encapsulated in monomer 265 represent the discontinuous phase droplets, and would have dimensions of less than one micron.

The emulsion from 120 is then subjected to reaction initiation, e.g., controlled chemical, redox or thermal initiation, to begin to polymerize the available monomers at 125. The reaction conditions will be dependent upon the chosen monomers and initiators, but example conditions include 70-95° C. for 0.01 to 10 hours at atmospheric pressures for thermal initiation. Depending on the reaction kinetics, polymerization is typically performed in a controlled environment. For example, regular or purified water can be degassed, deionized, or distilled along with an initial purge in an N₂ and/or Ar₂ atmosphere to reduce oxygen content of the reaction.

If it is desired to continue to drive the reaction at 130, e.g., when available reaction initiators are insufficient to fully react all available monomers, one or more additional reaction initiators can be added at 135. The degree of reaction completion can be determined by monitoring the monomer/polymer ratio of the reaction mixture or monitoring the rate of heat generation during the exothermic reaction. Additional reaction initiator may be added, for example, when the reaction times have exceeded the half-life of the initiator. Alternatively, additional initiator may be added in a controlled manner, such as adding particular quantities of initiator at particular intervals determined to maintain a desired reaction rate until a quantity of initiator has been added that is expected to cause complete consumption of the available monomers. FIG. 2C is a representation of a resulting reaction product after the available monomers 265 are reacted, and having an aqueous continuous phase 270 and a discontinuous phase having particles 260 encapsulated in a polymer 275. If the reaction is complete at 130, the process proceeds to 140. It is noted that reaction completion at 130 does not require complete consumption of available monomers. It only means that under the current reaction conditions, there is no longer a desire to drive the reaction through the addition of further initiator.

If the monomers of step 110 are sufficient to produce a desired encapsulant thickness at 140, the process may end at 150. In certain applications, such as inkjet printing, a weight ratio of polymer encapsulant to encapsulated solids of greater than one may be desired. However, combining sufficient monomer with the particles to produce such a weight ratio can lead to undesirable uniformity in the resulting polymer encapsulant. For example, the likelihood of monomer particles not containing a solid particle increases, leading to the formation of particle-free polymer, or the variation of polymer thickness from particle to particle may be increased. Thus, various embodiments mix an insufficient amount of monomer with the particles initially to reduce the likelihood of such particle-free polymer or undesirable thickness variability, and build subsequent polymer thickness using monomer-starved feeding conditions. Accordingly, if the monomers added at 110 are not sufficient to produce a desired encapsulant thickness at 140, one or more additional monomers are added at 145. The additional monomer at 145 can include the same one or more monomers used at step 110 to continue building the polymer encapsulant having the same composition. Alternatively, the additional monomer at 145 can include at least one monomer not used at step 110, such that a layer of different polymer is formed on the prior polymer layer. This process can be repeated until a desired thickness of the desired one or more polymer compositions is formed around the particles. The additional monomer at 145 may be added in a controlled manner such as found in monomer-starved polymerization processing. For example, the additional monomer may be added periodically via a syringe pump or the like, or continuously via a rotary feed pump or the like. Such monomer-starved conditions can facilitate a near elimination of particle-free polymer in the resultant reaction product. It is further noted that the addition of initiator at 135 and the addition of monomer at 145 may occur concurrently, and the addition of monomer at 145 may occur before the available monomer of the reaction mixture is fully consumed. The addition of monomer at 145 can be neat monomers, i.e., pure or in their commercially-available form, or a stabilized aqueous emulsion of monomers.

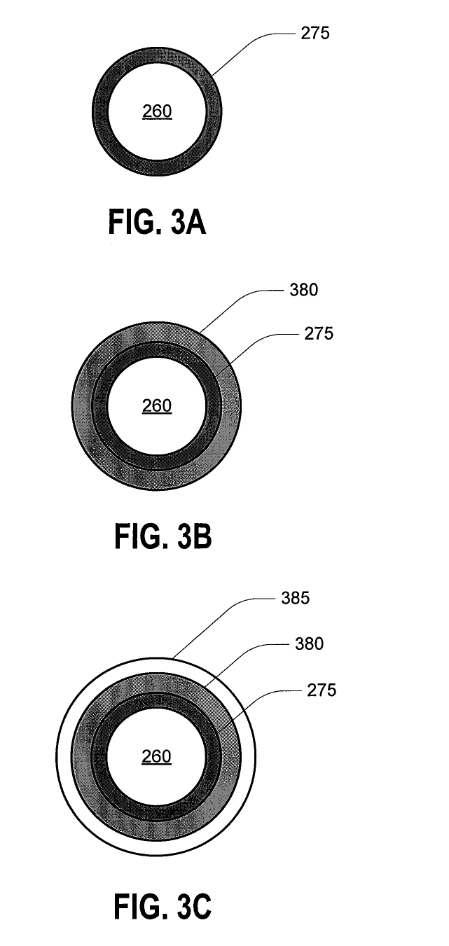

The formation of a polymer encapsulant having varying compositions is depicted in FIGS. 3A-3C. In FIG. 3A, a particle 260 is encapsulated by a polymer 275. Such an encapsulated particle may be obtained by following the process of FIG. 1 and using the same monomer(s) at 145 as were used at 110. In FIG. 3B, a particle 260 is encapsulated by a first polymer 275 having a first composition, which is then encapsulated by a second polymer 380 having a second composition different from the first composition. Such an encapsulated particle may be obtained by following the process of FIG. 1 and making a change in the monomer composition at 145 after a desired thickness of polymer 275 is obtained. In FIG. 3C, a particle 260 is encapsulated by a first polymer 275 having a first composition, which is then encapsulated by a second polymer 380 having a second composition different from the first composition, which is then encapsulated by a third polymer 385 having a third composition different from the second composition. Such an encapsulated particle may be obtained by following the process of FIG. 1, making a change in the monomer composition at 145 after a desired thickness of polymer 275 is obtained, and making another change in the monomer composition at 145 after a desired thickness of polymer 380 is obtained. Note that the composition of the third polymer 385 may be the same or different than the composition of the first polymer 275. This process can be repeated to form yet additional polymer layers.

The following examples represent processes used to form encapsulated particles in accordance with various embodiments of the disclosure. Each resulting reaction mixture can be used in the formulation of marking fluids for inkjet printing without additional processing or purification, i.e., all starting materials can be retained in the resultant marking fluid.

### Example 1

To 48 g of acrylic monomers (styrene/hexamethacrylate/methacrylic acid/ethylene glycol dimethacrylate, 25:68:6:1) was added 0.24 g of oil-soluble initiator azobisisobutylnitrile in a 1 L Erlenmeyer flask. 24 g of BASF D7079 cyan pigments were added to this initiator-containing solution in the increments of 0.5 g/30 seconds with stirring until all pigments were blended thoroughly into a viscous paste. 500 mL of a degassed deionized aqueous solution containing 8 g of sodium dodecylsulfate was added to this paste. The heterogeneous mixture was subjected to sonication with a VIBRACELL ultrasonifier at 50% amplitude with microtip No. 630-0419 for 2 minutes (1 second pulse in 9 seconds intervals) with external cooling. The resulting dispersion was further sonified at 60% and 70% amplitudes for 1 and 2 minutes, respectively, under the same condition until a stable emulsion was achieved and collected into a 1 L Morton-type reaction vessel, equipped with condenser and stirring mechanism. The solution was purged with an inert gas, i.e. argon, for 2-5 minutes, and then subjected to thermally initiated polymerization at 80° C. Upon 1 hour after the polymerization had started, an aqueous solution of 1.4 g potassium persulfate in degassed water (60 mL) was added dropwise to the reaction at a rate of 15 mL/hour. The reaction was allowed to proceed for another 3 hours and then it was quenched by adding 3 mL of water containing 50 mg of N,N-dimethylhydroxylamine hydrogen chloride and opened to air while allowed to cool to room temperature. The cooled mixture was screened through a 10 micron aluminum screen into storage bottle where 20 mL of an aqueous solution containing 2 g of Tergitol L-61 was added.

### Example 2

To 50 g of acrylic monomers (styrene/methylmethacrylate/hexamethacrylate/methacrylic acid/ethylene glycol dimethacrylate, 15:10:68:6:1) was added 0.24 g of oil-soluble initiator azobisisobutylnitrile in a 1 L Erlenmeyer flask. 26 g of CLARIANT B2GD cyan pigments were added to this initiator-containing solution in the increments of 0.5 g/30 seconds with stirring until all pigments were blended thoroughly into a viscous paste. 500 mL of a degassed deionized water solution containing 8 g of sodium dodecylsulfate was added to this paste. The heterogeneous mixture was subjected to sonication with a VIBRACELL ultrasonifier at 50% amplitude with microtip No. 630-0419 for 2 minutes (1 second pulse in 9 seconds intervals) with external cooling. The resulting dispersion was further dispersed by a microfluidizer (MICROFLUIDICS Model 110-Y) equipped with a 87 micron interaction chamber, in which the homogenizer was set to have an external pressure of 80 psi, equivalent to a theoretic internal shear pressure of 26000 psi inside the interaction chamber. The emulsion was processed for 1 minute with cooling at a rate of over 1 L/min. The stable emulsion was then collected into a 1 L Morton-type reaction vessel and purged with an inert gas, i.e. argon, for 2-5 minutes. The emulsion was then subjected to thermally initiated polymerization at 80° C. Upon 1 hour after the polymerization had started, an aqueous solution of 1.4 g potassium persulfate in degassed water (60 mL) was added dropwise to the reaction at a rate of 15 mL/hour. The reaction was allowed to proceed for another 3 hours and then it was quenched by adding 2 mL of water containing 50 mg of hydroquinone-monomethyl-ether and opened to air while allowed to cool to room temperature. The cooled mixture was screened through a 10 micron aluminum screen into storage bottle where 20 mL of an aqueous solution containing 2 g of Tergitol L-61 was added.

### Example 3

To 40 g of acrylic monomers (styrene/butylmethacrylate/acrylic acid/ethylene glycol dimethacrylate, 25:68:6:1) was added 22 g of HEUBACH 515400 cyan pigments in the increments of 0.5 g/30 seconds with stirring until all pigments were blended thoroughly into a viscous paste. 500 mL of a degassed deionized water solution containing 8 g of sodium dodecylsulfate and 0.24 g of potassium persulfate was added to this paste. The heterogeneous mixture was subjected to mechanical stirring by the mean of an overhead stirrer or high viscosity homogenizer at the rate of 1000 rpm under a stream of argon until a reasonable dispersion was obtained. This dispersion was further dispersed by a microfluidizer (MICROFLUIDICS Model 110-Y) equipped with a 87 micron interaction chamber, in which the homogenizer was set to have an external pressure of 80 psi, equivalent to a theoretic internal shear pressure of 26000 psi inside the interaction chamber. The emulsion was processed for 1 minute with cooling at a rate of over 1 L/min. The stable emulsion was then collected into a 1 L Morton-type reaction vessel and purged with an inert gas, i.e. argon, for 2-5 minutes. The emulsion was then subjected to thermally initiated polymerization at 80° C. Upon 1 hour after the polymerization had started, an aqueous solution of 1.4 g potassium persulfate in degassed water (60 mL) was added dropwise to the reaction at a rate of 15 mL/hour. The reaction was allowed to proceed for another 3 hours and then it was quenched with 50 mg of hydroquinone dissolved in 5 mL of water, opened to air while allowed to cool to room temperature. The cooled mixture was screened through a 10 micron aluminum screen into a storage bottle.

### Example 4

To 48 g of acrylic monomers (styrene/hexamethacrylate/methacrylic acid/ethylene glycol dimethacrylate, 25:68:6:1) was added 0.24 g of oil-soluble initiator azobisisobutylnitrile in a 1 L Erlenmeyer flask. 12 g of Versathane 1090was then added to monomer mix. 30 g of BASF D7079 cyan pigments were added to this initiator-containing solution in the increments of 0.5 g/30 seconds with stirring until all pigments were blended thoroughly into a viscous paste. 500 mL of a degassed deionized aqueous solution containing 8 g of sodium dodecylsulfate was added to this paste. The heterogeneous mixture was subjected to sonication with a VIBRACELL ultrasonifier at 50% amplitude with microtip No. 630-0419 for 2 minutes (1 second pulse in 9 seconds intervals) with external cooling. The resulting dispersion was further refined by passing through a microfluidizer (MICROFLUIDICS Model 110-Y) equipped with a 200 micron auxiliary process module in series with an 87 micron interaction chamber at 250 mL/min for 5 minutes with external cooling at 0° C. until a stable emulsion was achieved and collected into a 1L Morton-type reaction vessel, equipped with condenser and stirring mechanism. The solution was purged with an inert gas, i.e. argon, for 2-5 minutes, and then subjected to thermally initiated polymerization at 80° C. Upon 1 hour after the polymerization had started, an aqueous solution of 1.4 g potassium persulfate in degassed water (60 mL) was added dropwise to the reaction at a rate of 15 mL/hour. The reaction was allowed to proceed for another 3 hours and then it was quenched with N-hydroxylamine and opened to air while allowed to cool to room temperature. The cooled mixture was screened through a 10 micron aluminum screen into storage bottle

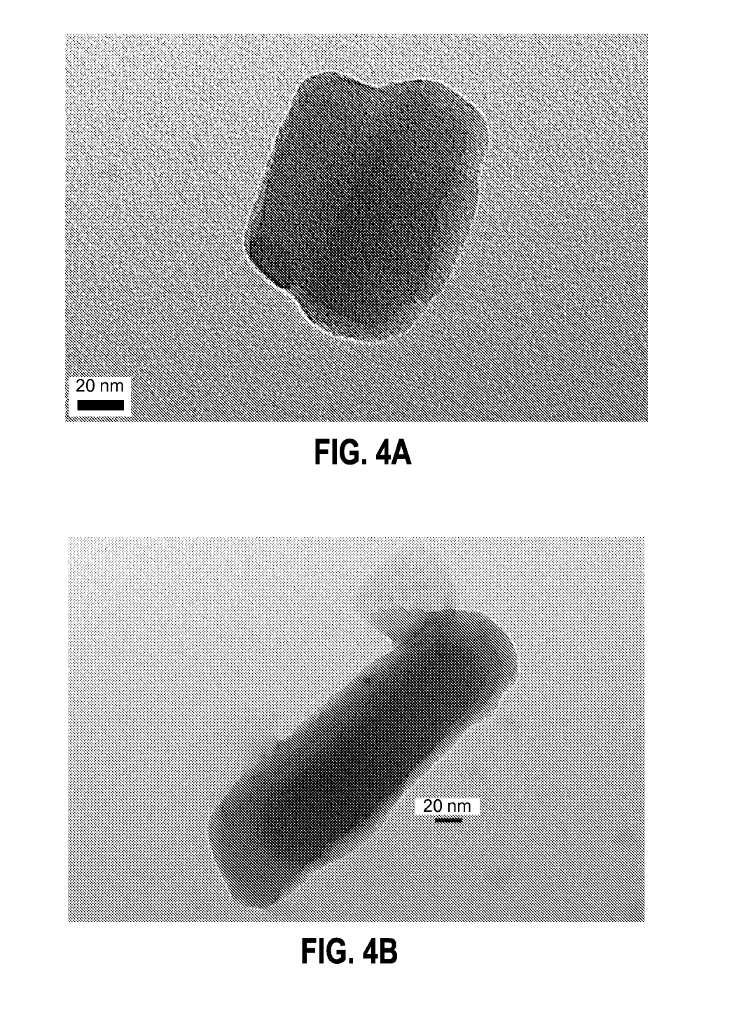

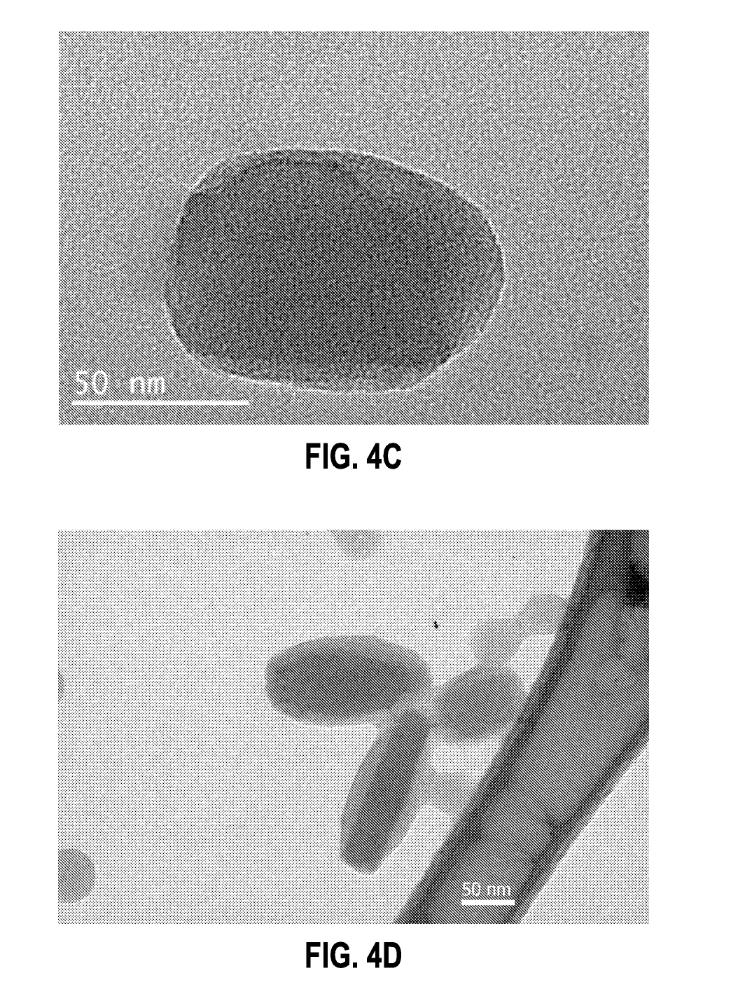

FIGS. 4A-4D are transmission electron micrograph (TEM) images of encapsulated particles produced in accordance with embodiments of the disclosure. FIG. 4A depicts two nanoparticles encapsulated together in a single polymer encapsulant using a process in accordance with an embodiment of the disclosure. FIG. 4B depicts a single nanoparticle encapsulated in a single polymer encapsulant using a process in accordance with an embodiment of the disclosure. FIG. 4C depicts another single nanoparticle encapsulated in a single polymer encapsulant using a process in accordance with an embodiment of the disclosure. FIG. 4D depicts two distinct nanoparticles, each encapsulated in a single polymer encapsulant using a process in accordance with an embodiment of the disclosure. Note that the branch-like structure is an anomaly of the TEM apparatus, and does not represent any encapsulated particles.

Various embodiments described herein are applicable to a wide range of nanoparticles of any shape. They can accommodate both dried nanoparticles and nanoparticle dispersions as starting materials, simplifying traditional mini-emulsion polymerization processes which utilize predispersed pigments, to a sequential, efficient and semi-continuous process scalable to industrial scale. In addition, the various embodiments can tolerate wide variations in surface properties of the nanoparticles.

Although specific embodiments have been illustrated and described herein it is manifestly intended that the scope of the claimed subject matter be limited only by the following claims and equivalents thereof. For example, solvent may be added to a monomer/pigment blend to facilitate the salvation of pigment into the monomer. Under such conditions, the resulting polymer could appear colored even without the encapsulation of any discrete pigment particle. The advantage from such a process is the improvement on optical density arising from colored pigment-free polymer.

What is claimed is:

1. A method of encapsulating particles (260) in polymer, comprising:
mixing particles (260) of one or more materials with one or more initial polymerizable monomers (265) to form a first suspension of monomer-wetted particles (260/265);
mixing the first suspension with an aqueous dispersant medium (270) to form a second suspension;
adding one or more initial reaction initiators to at least one of the first suspension and the second suspension;
subjecting the second suspension to homogenization sufficient to form a stable submicron emulsion having an aqueous continuous phase (270); and
reacting available polymerizable monomers (265) of the emulsion to encapsulate the particles (260) in one or more layers of polymer (275, 380, 385).

2. The method of claim 1, wherein mixing particles (260) of one or more materials with one or more initial polymerizable monomers (265) further comprises mixing particles (260) of one or more materials with the one or more initial polymerizable monomers (265) and at least one additional reagent selected from the group consisting of a reaction initiator, a crosslinker, a co-surfactant, a rheology-control agent, a chain transfer agent, a dithioester and a non-aqueous solvent.

3. The method of claim 1 or 2, wherein mixing particles (260) of one or more materials with one or more initial polymerizable monomers (265) further comprises shearing the first suspension sufficient to cause a reduction in average particle size of the particles (260).

4. The method of any of claims 1-3, further comprising:
adding one or more additional reaction initiators while reacting the available polymerizable monomers (265) of the emulsion.

5. The method of claim 4, wherein adding one or more additional reaction initiators comprises adding at least one reaction initiator that is different than any of the one or more initial reaction initiators.

6. The method of any of claims 1-5, further comprising:
adding one or more additional polymerizable monomers (265) to the emulsion; and
continuing to react the available polymerizable monomers (265) of the emulsion.

7. The method of claim 6, wherein adding one or more additional polymerizable monomers (265) comprises adding at least one polymerizable monomer (265) that is different than any of the one or more initial polymerizable monomers (265).

8. The method of any of claims 1-7, further comprising:
adding one or more additional reaction initiators while reacting the available polymerizable monomers (265) of the emulsion; and
adding one or more additional polymerizable monomers (265) to the emulsion while reacting the available polymerizable monomers (265) of the emulsion;
wherein adding one or more additional reaction initiators and adding one or more additional polymerizable monomers (265) occur concurrently while continuing to react the available polymerizable monomers (265) of the emulsion.

9. The method of any of claims 1-8, further comprising adjusting the homogenization process conditions to obtain a particular degree of deagglomeration of the monomer-wetted particles (260/265) in the aqueous continuous phase (270).

10. The method of any of claims 1-8, further comprising adjusting the homogenization process conditions to obtain a particular average size of the monomer-wetted particles (260/265) in the aqueous continuous phase (270).

11. The method of any of claims 1-8, wherein subjecting the second suspension to homogenization comprises processing the second suspension in an apparatus selected from the group consisting of a homogenizer, an ultrasonifier, a microfluidizer and an ultrasonicator.

12. A composition of matter comprising one or more particles (260) encapsulated in one or more layers of polymer (275, 380, 385) and produced using the method of claim 1.

13. The composition of matter of claim 12, wherein the composition of matter is a marking fluid.

14. A composition of matter, comprising:
at least one nanoparticle (260);
a first polymer layer (275) encapsulating the at least one nanoparticle (260); and
a second polymer layer (380) encapsulating the first polymer layer (275);
wherein the second polymer layer (380) comprises a different polymer composition than a polymer composition of the first polymer layer (275).

15. The composition of matter of claim 14, further comprising:
a third polymer layer encapsulating the second polymer layer (380);
wherein the third polymer layer comprises a different polymer composition than the polymer composition of the second polymer layer (380).
